(19) United States
(12) Patent Application Publication
(10) Pub. No.: US 2006/0021066 A1
(43) Pub. Date: Jan. 26, 2006

(54) Data encryption system and method

(76) Inventors: Ray Clayton, Madison, AL (US); Eliel J. Mendoza, Carnation, WA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/989,731

(22) Filed: Nov. 16, 2004

Related U.S. Application Data
(60) Provisional application No. 60/591,044, filed on Jul. 26, 2004.

(51) Int. Cl. H04L 9/32; H04K 1/00; G06F 17/30; H04L 9/00; G06F 7/04; G06K 9/00; H03M 1/68; H04N 7/16

(52) U.S. Cl. 726/28; 713/186

(57) ABSTRACT

An encryption system comprises memory for storing a data file and a decryption application. The decryption application is configured to authenticate a user and to receive a data packet. The data packet has a data message encrypted via an encrypted encryption key that is embedded within the data packet. The decryption application is configured to decrypt the data message based on the embedded encryption key and to interface the decrypted data message with the user if the user is authenticated by the decryption application. The decryption application is configured to recover the encryption key and to decrypt the data message based on data within the data packet and based on data within the data file, and the decryption application controls access to the data within the data file based on whether the user is authenticated by the decryption application.

### CROSS REFERENCE TO RELATED APPLICATION

This application claims priority to U.S. Provisional Application Ser. No. 60/591,044, entitled “Data Encryption System and Method” and filed on Jul. 26, 2004, which is incorporated herein by reference.

### RELATED ART

There exist various methods for securely transmitting data between communication devices. One such technique is public key encryption (PKE) and is described in more detail with reference to FIG. 1.

FIG. 1 depicts a conventional encryption system 100 comprising a certified key generator 102, a data-receiving unit 112 and a data-transmitting unit 120 that communicate via a network 123. The certified key generator 102 comprises key generation logic 104 that creates one or more key pairs 106, each of which comprises a public key 108 and a private key 110 that corresponds to the public key 108 of the same pair 106.

The data-receiving unit 112 requests a key pair 106 from the certified key generator 102. In response, the certified key generator 102 transmits a public key 108 and corresponding private key 110 to the data-receiving unit 112, and the data-receiving unit 112 transmits the public key 108 to one or more data-transmitting units 120. In addition, the data-receiving unit 112 retains the private key 110.

If a data-transmitting unit 120, which has received a public key 108 corresponding to the private key 110 saved on the data-receiving device 112, desires to transmit data 122 to the data-receiving unit 112, then the encryption logic 124 encrypts the data 122 using the public key 108 to obtain encrypted data 118.

The data-transmitting unit 120 transmits the encrypted data 118 to the data-receiving device 112. The decryption logic 114 then uses the private key 110 retained on the data-receiving unit 112 to decrypt the encrypted data 118 to obtain the original data 122. In this regard, the decryption logic 114 typically matches the public key 108 and the private key 110 in order to decrypt the encrypted data 118.

It is possible for an unauthorized user, sometimes referred to as a “hacker,” to try to obtain access to the data 122. For example, the “hacker,” after gaining access to the data 118, may be able to “spoof” the certified key generator 102 to provide him with the private key 110 to enable the hacker to decrypt the data 118. In this regard, the hacker may purport to be a valid key owner who has lost his private key by using the data-receiving unit's identification information, e.g., the unit's internet protocol address or the unit's designated email address.

In addition, a hacker may be able to intercept a public key 108 intended for a valid data-transmitting unit 120. In this regard, the unintended recipient of the public key 108 can then transmit validly encrypted data 118 that is encrypted using the misappropriated public key 108. In such a case, the data-receiving unit 112 may be unable to identify the data 118 as coming from an unreliable source since the data 118 is encrypted with a valid public key.

### SUMMARY OF THE DISCLOSURE

Generally, embodiments of the present disclosure provide data encryption systems and methods.

A system in accordance with one embodiment of the present disclosure comprises memory for storing a data file and a decryption application. The decryption application is configured to authenticate a user and to receive a data packet. The data packet has a data message encrypted via an encrypted encryption key that is embedded within the data packet. The decryption application is configured to decrypt the data message based on the embedded encryption key and to interface the decrypted data message with the user if the user is authenticated by the decryption application. The decryption application is configured to recover the encryption key and to decrypt the data message based on data within the data packet and based on data within the data file, and the decryption application controls access to the data within the data file based on whether the user is authenticated by the decryption application.

A method in accordance with another embodiment of the present disclosure comprises the steps of: storing a data file; receiving a data packet, the data packet having a data message and an encrypted encryption key, the data message encrypted via the encrypted encryption key, the data packet also having data that enables decryption of the encrypted encryption key; authenticating a user; accessing data within the data file if the user is authenticated via the authenticating step; decrypting the encrypted encryption key based on the data that enables decryption of the encrypted encryption key; decrypting the data message based on the encryption key; interfacing the decrypted data message with the user; and enabling at least one of the the decrypting the data message step and the interfacing step based on the data accessed via the accessing.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram illustrating a conventional encryption system.

FIG. 2 is a block diagram illustrating an encryption system in accordance with an exemplary embodiment of the present disclosure.

FIG. 3 is a block diagram illustrating an exemplary data-receiving unit of FIG. 2.

FIG. 4 is a flowchart illustrating exemplary architecture and functionality of a data-transmitting unit of FIG. 2.

FIG. 5 is a flowchart illustrating exemplary architecture and functionality of a data-receiving unit of FIG. 2.

FIG. 6 is a block diagram illustrating a communication system in accordance with another embodiment of the present disclosure.

### DETAILED DESCRIPTION

Embodiments of the present disclosure generally pertain to systems and methods for encrypting and decrypting data communicated between various devices, e.g., personal computers (PC) and/or a server and a PC.

A system in accordance with one embodiment of the present disclosure encrypts data using an encryption key and encrypts the encryption key. The system then transmits, to a receiving unit, a data message, e.g., a data packet, that comprises the encrypted data and the encrypted key. The encrypted key preferably comprises key decryption data that comprises a ciphered string of data that the receiving unit uses to extract the encrypted key from the data packet.

Upon receipt of the encrypted data, the encrypted key and key decryption data, logic residing on the receiving unit deciphers the key decryption data and uses the deciphered data to extract the key from the data packet. The unit then decrypts the encrypted key using the key decryption data and known techniques after authentication of a user at the receiving unit. In one embodiment, user verification is achieved by matching authentication data stored in the receiving unit with biometric data received from the user, for example, via a fingerprint scan or a retinal scan.

A system in accordance with one embodiment of the present disclosure provides secure communication for electronic mail, hereinafter referred to as “email.” In such an embodiment, the communicating devices exchange data that uniquely identifies each communicating device prior to exchanging email messages. Therefore, when a transmitting unit generates an encrypted data message, it transmits along with the encrypted data an encrypted key that comprises data identifying the transmitting unit and the receiving unit. The receiving unit decrypts the encrypted key, retrieves the identifying data, and compares the retrieved data with the identifying data received from the transmitting device to ensure that the data was transmitted from a reliable source.

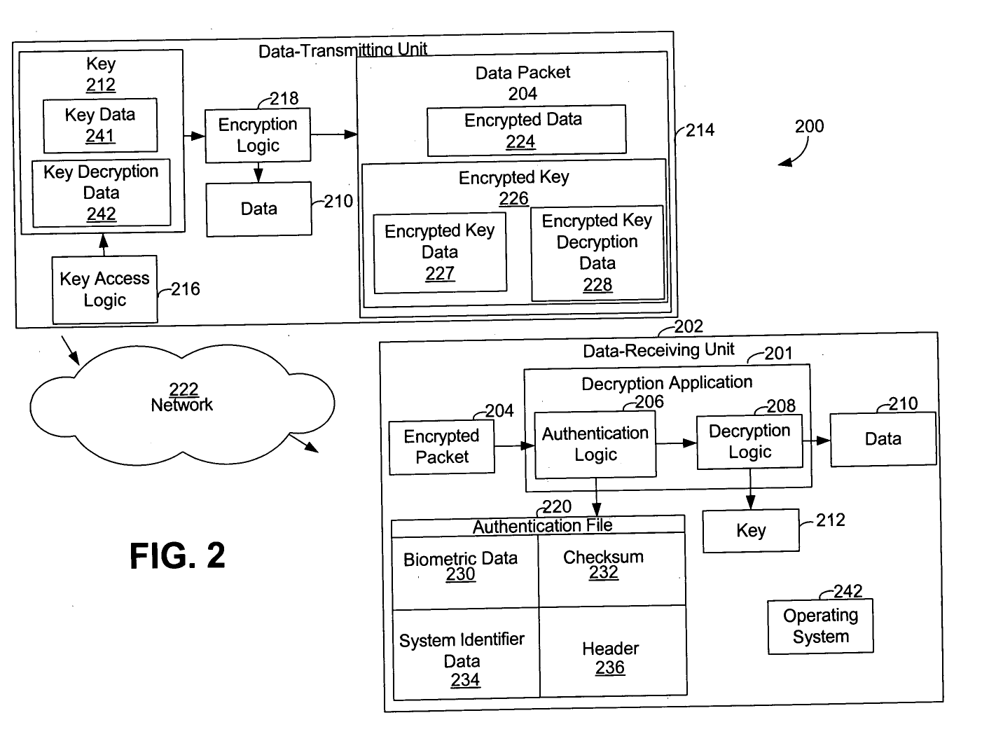

FIG. 2 depicts a system 200 in accordance with an exemplary embodiment of the present disclosure. System 200 comprises a data-transmitting unit 214 and a data-receiving unit 202 communicating via a network 222.

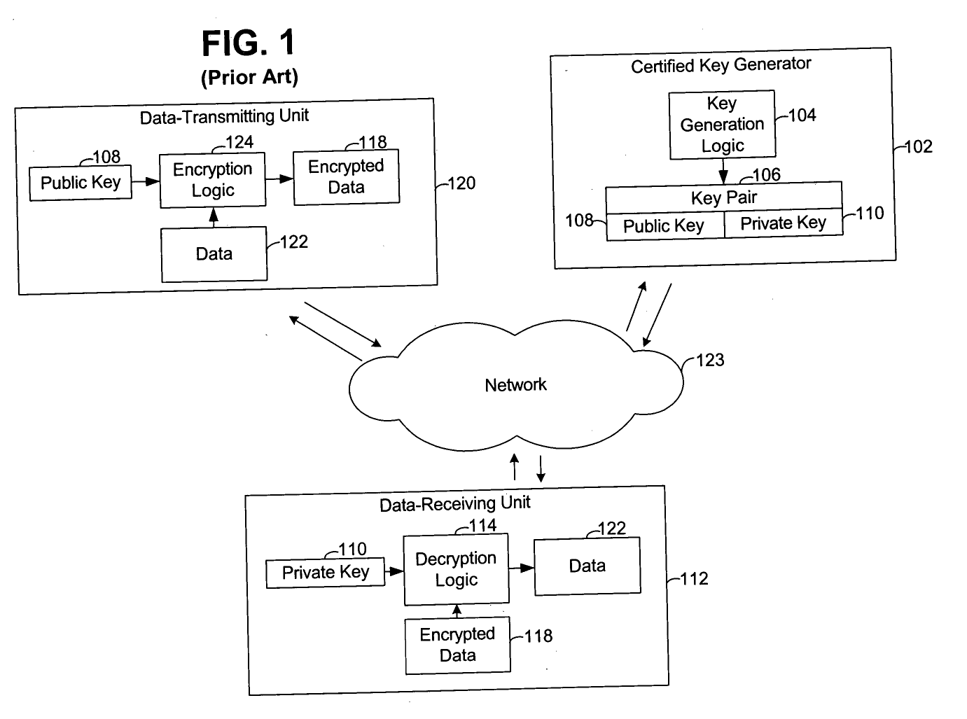

The data-transmitting unit 214 comprises key access logic 216 and encryption logic 218. The key access logic 216 may use any number of techniques known in the art to provide a key 212. For example, a key 212 may be a public key for use in conjunction with any known public/private key encryption technique, such as data encryption standard (DES), public key encryption (PKE), and advanced encryption standard (AES). In such an embodiment, the key 212 may be obtained from a remote source, such as the data-receiving unit 202 or the certified key generator 102 shown in FIG. 1. In another embodiment, the key 212 may be generated by the key access logic 216 using any known key generation technique, such as a technique that incorporates a random number generator algorithm to provide a unique key.

When generating the key 212, the key access logic 216 generates key data 241 and key decryption data 242. The key decryption data 242 preferably comprises a ciphered string that can be used in order to decrypt the encrypted key 226. The key data 241 and the key decryption data 242 may comprise data indicative of various information, such as a date, time, Boolean variable and/or random number, for example.

After the logic 216 provides the key 212, the encryption logic 218 encrypts the data 210 using such key 212 via suitable encryption techniques known in the art thereby generating encrypted data 224. Further, the encryption logic 218 encrypts the generated key 212 generating encrypted key 224 also using any number of techniques known in the art as described above. In this regard, the logic 218 encrypts the key data 241 to generate encrypted key data 226 and encrypts the key decryption data 242 to generate encrypted key decryption data 228.

The encryption logic 218 then generates a data packet 204. The data packet 204 comprises the encrypted data 224 and the encrypted key 226, which further comprises the encrypted key data 227 and encrypted key decryption data 228.

As will be described below, the key decryption data 228 enables the data-receiving unit 202 to decrypt the encrypted key 226. For example, in one embodiment, the decryption data 228 comprises data indicative of one or more points of reference that enable the encrypted key data 227 to be extracted from the encrypted key 226. The transmitting unit 214 then transmits the data packet 204 to the data-receiving unit 202 via the network 222.

The data-receiving unit 202 comprises a decryption application 201 that comprises authentication logic 206 and decryption logic 208. Additionally, data-receiving unit 202 comprises authentication file 220. The resources of the data-receiving unit 202, including the decryption application 201 and the authentication file 220 are managed by an operating system 242, which may be implemented by any know operating system, such as Microsoft® Windows®.

The authentication file 220 comprises authentication data, such as biometric data 230, system identifier data 234, a header 236, and checksum data 232. The biometric data 230 may comprise data indicative of the user's fingerprint, retina, acoustic features or facial features. Further, the file 220 may comprise an individual's email address or Internet protocol (IP) address as unique identification data. The header 236 preferably comprises data indicative of the date of original creation of the authentication file 220, date and time of last modification of the authentication file 220, and/or the date and time of the most recent access of the authentication file 220. Such header data 236 may form a part of the authentication file 220. However, such header information 236 may be stored by the operating system 242 of the data-receiving unit 202 in nonvolatile memory (not shown) in a file allocation table (not shown), as is done by most conventional operating systems.

Upon activation, the decryption application 201 authenticates the user of the unit 202, as will be described in more detail hereafter. After the packet 204 has been received by the unit 202 and the user has been authenticated, the decryption logic 208 deciphers the key decryption data 228 and extracts and decrypts the key data 227 from the encrypted key 226 included in the data packet 204.

The logic 208 then decrypts the packet's encrypted key 226 using decryption techniques known in the art and uses the decrypted key to decrypt the encrypted data 224. In this regard, the decryption application 201 is configured to locate, in the key decryption data 228, the data that the decryption application 201 uses in order to extract any key data 227 and decrypt the key 226. Once the decryption logic 208 decrypts the encrypted key 226, it can then decrypt the data 224 using the decrypted key.

Various techniques may be employed to encrypt and decrypt the key that is embedded in the message transmitted to the data receiving unit 202. In one exemplary embodiment, the decryption application 201 uses a predefined algorithm to process the key decryption data 242 to enable decryption of the encrypted key 226. For example, the encryption logic 218 may be configured to define the decryption data 242 such that when it is processed according to the predefined algorithm by the decryption application 201, the predefined algorithm provides a pointer or other type of data that points to or otherwise identifies the encrypted key 226 that is embedded in the received packet. At this point, the identified key 226 can be decrypted via any suitable technique.

In one embodiment, the predefined data uses not only the key decryption data 242 in the packet but also data stored at the data-receiving unit 202 to enable decryption of the encrypted key 226. For example, the decryption application 202 may be configured to combine the decryption data 242 retrieved from a received packet with data stored in the authentication file 220 in order to provide a pointer or other type of information for pointing to or otherwise identifying the encrypted key 226 within the received packet. If desired, the key decryption data 242 or a portion thereof may be used as a key or part of a key for decrypting the encrypted key 226.

In one exemplary embodiment, the encryption logic 218 combines a random number with a transmitting unit identifier (i.e., a unique identifier identifying the data-transmitting unit 214) and a receiving unit identifier (i.e., a unique identifier identifying the data-receiving unit 202). Using this combined value as the key 212, the encryption logic 218 encrypts at least a portion of the data packet to be transmitted. The encryption logic 218 also encrypts the key 212 to provide encrypted key 226, which is embedded in the packet to be transmitted. The encryption logic 218 then defines the decryption data 242 such that the decryption application 201 is able to decrypt the key 226.

The authentication file 220 comprises system identifier data 234, which in the instant example comprises the transmitting unit identifier and the receiving unit identifier. In other embodiments, the data 234 may comprise other types of information. If the user of the data-receiving unit 202 is authenticated via known authentication techniques or authentication techniques described herein, the decryption application 202, using the decryption data 242 from the received packet and the system identifier data 234, identifies the encrypted key 226 or otherwise enables the decryption application 201 to decrypt the encrypted key 226. It should be noted, however, that the foregoing techniques for enabling encryption and decryption of the key 212 are exemplary and various other techniques may be employed to enable the decryption application 201 to recover the key 212.

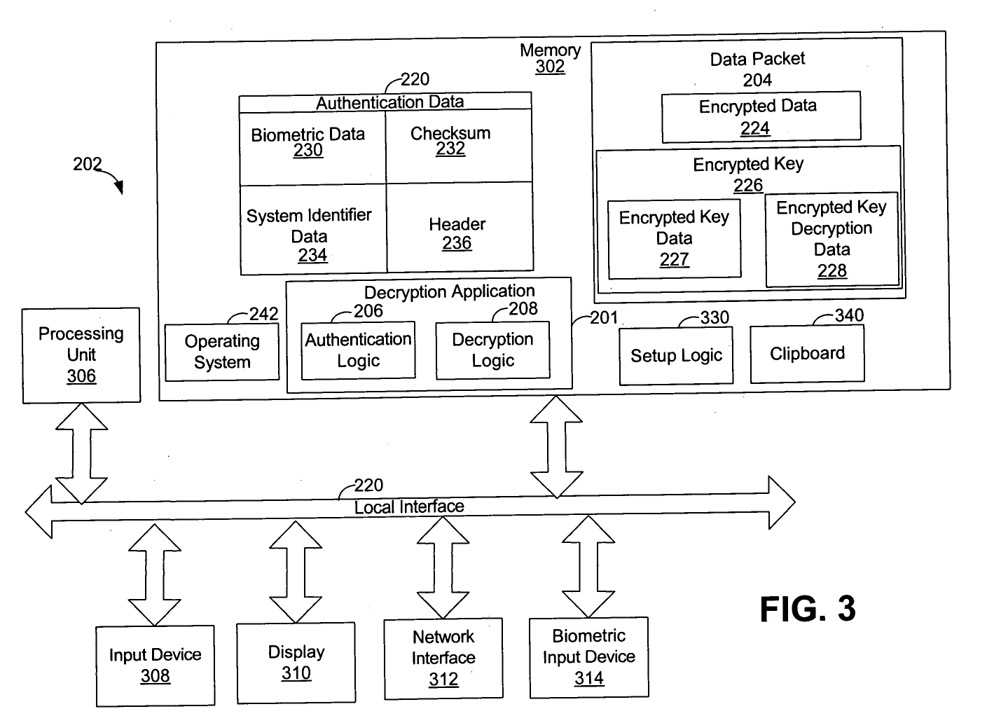

FIG. 3 depicts an exemplary data-receiving unit 202 of the present disclosure.

The exemplary data-receiving unit 202 generally comprises a processing unit 306 and memory 302. The processing unit 306 may be a digital processor or other type of circuitry configured to run the decryption application 201 by processing and executing the instructions of the application 201. The processing unit 306 communicates to and drives the other elements within the unit 202 via a local interface 320, which can include one or more buses. Furthermore, an input device 308, for example, a keyboard, a switch, a mouse, and/or other type of interface, can be used to input data from a user of the unit 202, and display unit 310 can be used to output data to the user. A biometric input device 314 can be connected to the local interface 320, such as one or more buses, to capture biometric data, e.g., hand reader, fingerprint readers, voice and face verification devices. The unit 202 can be connected to a network interface 312 that allows the unit 202 to exchange data with a network 222 (FIG. 2).

In the exemplary data-receiving unit 202 of FIG. 3, the decryption application 201 comprising the authentication logic 206 and the decryption logic 208 is shown as being implemented in software and stored in memory 302. However, the decryption application 201 may be implemented in hardware, software or a combination of hardware and software in other embodiments.

The receiving unit 202 also comprises an input device 308 and a display device 310. Examples of input devices may include, but are not limited to, a keyboard device, serial port, scanner, camera, microphone, credit/debit card reader, money slot, or local access network connection. Examples of output devices may include, but are not limited to, a video display, a Universal Serial Bus, document generator, a printer port or a local access network (LAN) connection.

As noted herein, the decryption application 201 comprising the authentication logic 206 and the decryption logic 208 is shown in FIG. 3 as software stored in memory 302. When stored in memory 302, the decryption logic 208 can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Upon installation of the decryption application 201 or upon registration of a new user, a user of the receiving unit 202 provides information that is stored as biometric data 230 of a newly created authentication file 220. In this regard, the biometric input device 314 captures data indicative of at least one biometric characteristic of the user of the data-receiving unit 202. In so capturing, the decryption logic 201 stores the biometric data 230 within the authentication file 220.

In addition, the decryption application 201 applies an algorithm that calculates a checksum for the authentication file 220. The checksum algorithm utilized determines a checksum value indicative of information associated with the authentication file 220. For example, the checksum algorithm may calculate a checksum value indicative of an algorithmic sum of the information associated with the file 220, such as the date and time stamps associated with the authentication file contained within the file's header data 232, as described hereinabove. The checksum value 302 may be stored within the authentication file 220, or alternatively, the value may be stored in nonvolatile memory associated with the receiving unit 202.

In this regard, when opening the authentication file 220, the authentication logic 206 may initially determine whether the authentication file 220 is secure by analyzing the checksum 232. For example, when the application 201 opens the authentication file 220, the logic 208 may initially analyze the authentication file 220 and calculate an algorithmic sum of the data contained therein, including the header data 236. Note that the algorithm used to calculate this algorithmic sum is the same algorithm used to calculate the previously stored checksum value.

The logic 208 then compares the sum calculated to the checksum value 232 stored in memory 302. If the checksum value calculated and the checksum value 232 stored in memory 302 differ, then the logic 208 preferably determines that the file 220 is corrupt and refrains from using the file 220. Thus, the logic 208 prevents the file 220 from being used for decryption by the application 201 if it appears that the authentication file 220 has been corrupted in some manner, for example by a hacker, as indicated by the differing checksum values.

If the file 220 has not been corrupted, the authentication logic 206 preferably recalculates a checksum value corresponding to the presently initiated opening of the file 220 before closing the file 220. Thus, the next time that the authentication logic 206 opens the file 220, the checksum comparison will not result in a corrupt file determination unless the file 220 has been opened by another unauthorized application. In this regard, it is highly unlikely that another application will be configured to update the checksum 232 after gaining access to the file 220 in the manner updated by the authentication logic 206, yet typical operating systems are configured to update the header 236 each time the file 220 is accessed by any application. Thus, if another application accesses the file 220, the checksum calculated by the authentication logic 206 the next time this logic 206 opens the file will not match the stored checksum. Thus, a corrupt determination based on the checksum comparison means that the file 220 has been accessed by an unauthorized application.

If logic 208 determines, based on the checksum comparison, that a would-be hacker has not corrupted the authentication file 220, then the logic 208 continues with the decryption process.

When authenticating a user of the data-receiving unit 202, the logic 208 requests that the user provide certain biometric data to be compared with the biometric data 230 previously stored in the file 220. Therefore, the logic 208 may display a user interface via display device 310 that prompts the user to enter such biometric data via the biometric input device. For example, the user may place his finger on a fingerprint scanner. Thus, the logic 208 receives biometric data representative of the user's fingerprint.

In order to continue with the decryption process, the logic 208 then compares the biometric data received via the biometric input device 314 with biometric data previously provided by an authorized user (e.g., the user that installed the decryption application). If the biometric data previously provided is substantially similar to the biometric data captured by the biometric input device 314, then the logic 208 continues with the decryption process.

If the biometric data captured and the biometric data 230 stored in memory 302 is substantially similar, then the logic decryption logic 208 uses the authentication file data in conjunction with the decryption data 228 in order to decrypt the encryption key 226. Once the key is decrypted, the logic 208 applies decryption techniques known in the art in order to decrypt the encrypted data 224.

Furthermore, the processing unit 306 of an embodiment of the receiving-unit 202 may comprise a clipboard 340 in memory 302. A clipboard, in general, is a set of memory typically used by an operating system to perform copy operations. In this regard, when a copy operation is requested by an application, the data to be copied is usually stored temporarily in the clipboard. Thereafter, this data is written to a desired destination.

The operating system 242, like conventional operating systems, is configured to temporarily store data on the clipboard 340 when performing a copy operation.

As a security feature, the application 201 enables the sender of data packet 204 to prevent the receiving unit 202 from successfully making copies of the unencrypted data 210 (FIG. 2). In this regard, when the user of the transmitting unit 214 provides an input indicating that copies of unencrypted versions of the data 224 are to be prevented, the encryption logic 218 includes in the packet 204 information indicative of this desire. The decryption logic 208 of the receiving unit 202 is configured to detect whether such information is included in the packet 204 and, if so, to prevent the clipboard 340 from being used to make copies of the unencrypted data 210.

In this regard, for as long as the application 201 is maintaining an unencrypted version of the data 224 (e.g., is displaying the unencrypted data 210 via display device 310), the application 201 repetitively writes to the clipboard 340 with sufficiently high frequency to prevent the clipboard 340 from being used to successfully copy the unencrypted data. In particular, the application 201 writes to the clipboard 340 frequently enough such that any data written to the clipboard 340 by another application is overwritten by the application 201 before such data can be successfully written from the clipboard 340 to another location. For example, in one embodiment, the application 201 writes a message to the clipboard 340 approximately every millisecond. The message indicates to a user that copy operations are disabled so that the user is aware of this if he views the message written from the clipboard 340. The amount of data repetitively written to the clipboard 340 by the application 201 is preferably small so that processing resources of the unit 202, including the operating system 242, are not unduly burdened. In other embodiments, different messages or data may be written to the clipboard 340 by the application 201, and the application 201 may write to the clipboard 340 at different frequencies.

Accordingly, if a user of the receiving unit 202 attempts to make a copy of the unencrypted data 210, the operating system 242 causes a copy of the unencrypted data 210 to be written to the clipboard 340. However, before this copy can be successfully written from the clipboard 340 to another location, the application 201 by repetitively writing to the clipboard 340 overwrites the copy of the unencrypted data 210. Thus, copy operations using the clipboard 340 are effectively disabled by the application 201.

Note that once the data 210 is deleted or overwritten such that no unencrypted version of the data 224 exists on the receiving unit 202, it is unnecessary for the application 201 to continue writing to the clipboard 304. Further, to prevent the data 210 from being copied after the application 201 is terminated or closed, the application 201 preferably ensures that the data 210 is deleted before terminating or closing.

In other embodiments, the operating system 242 may be designed to allow copy operations to be disabled by applications, such as the decryption application 201, by submitting a function call to the operating system 242. However, disabling copy operations by repetitively writing to the clipboard 340, as described above, has the advantage of being able to use commercially available operating systems, which are not typically designed to allow applications to disable copy operations.

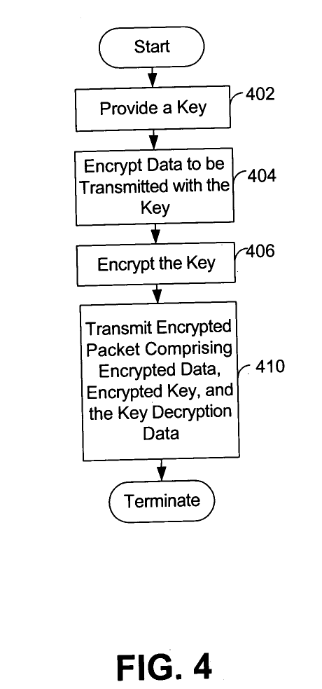

An architecture and functionality of the system 200 (FIG. 2) is described with reference to FIGS. 4-6.

FIG. 4 is a flowchart illustrating an exemplary architecture and functionality of the key access logic 216 (FIG. 2) and the encryption logic 218 (FIG. 2) of the data-transmitting unit 214 (FIG. 2). The key access logic 216 preferably provides a unique key 212 comprising key data 241 and key decryption data 242 associated with the data that is to be encrypted and transmitted to the data-receiving unit 202 in step 402.

The encryption logic 218 encrypts the data to be transmitted to the data-receiving unit 202 using the key 212 in step 404. Once the data is encrypted with the key 212, the encryption logic 218 then encrypts the key 212 to provide encrypted key 226 in steps 406.

The encryption logic 218 then transmits a data packet 204 (FIG. 2) to the data-receiving unit 202 in step 410. As noted in step 410, the data packet 204 comprises the encrypted data 224 and the encrypted key 226. The data-transmitting unit 214 generates a unique key 212 each time that the data-transmitting unit 214 sends data to the data-receiving unit 202, although using the same key 212 for multiple messages is possible in other embodiments.

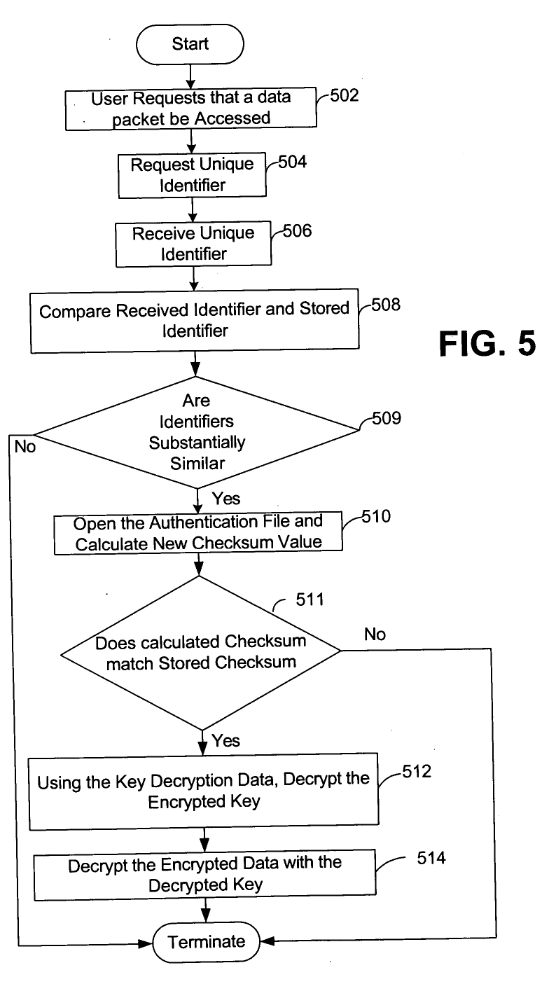

FIG. 5 is a flowchart depicting an exemplary architecture and functionality of the decryption application 201 (FIG. 2) of the data-receiving unit 202 (FIG. 2).

A user invokes the-decryption application 201 and requests access to a data packet 204 (FIG. 2), as indicated in step 502. The decryption application 201 of the data-receiving unit 202 requests via the display device 310 that the user enter a unique identifier via an input device, e.g., the biometric input device 314, in step 504 to enable the application 201 to authenticate the user. In one embodiment, the unique identifier is biometric data, such as a fingerprint. In other embodiments, other types of unique data, such as a password, may be requested and used as the unique identifier.

The application 201 receives the unique identifier in step 506 and compares the unique identifier with a user identifier stored in the authentication file 220, e.g., biometric data 230, in step 508. If the received identifier and the stored identifier are substantially equivalent or otherwise correspond in step 509, then the decryption application 201 opens the authentication file 220 in step 510. The application 201 then calculates a new checksum value and compares the calculated value to the stored checksum value 232 (FIG. 2).

If the values are equivalent indicating that the file is not corrupt, then the application 201 decrypts the encrypted key 226 using the key decryption data 228 in step 512. In this regard, the application 201 decrypts the key 212 based upon the authentication file 220 and the decryption data 228. The application 201 then decrypts the encrypted data 224 with the decrypted key in step 514.

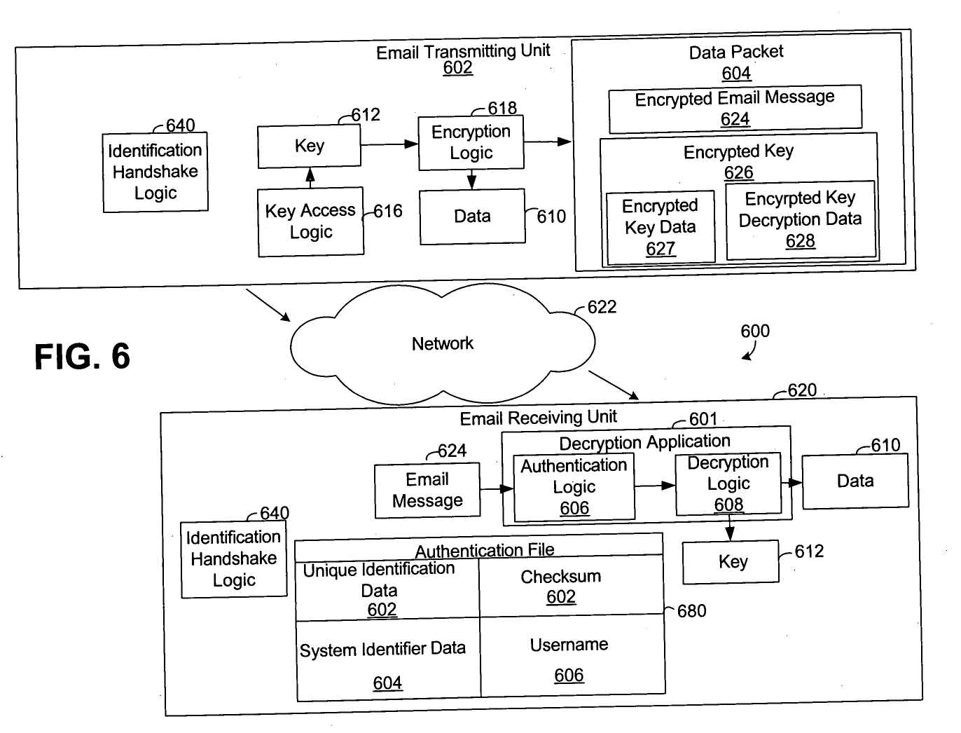

FIG. 6 depicts another system 600 in accordance with yet another embodiment of the present disclosure.

The system 600 comprises an email-transmitting unit 602 and an email-receiving unit 620. The email-transmitting unit 602 and the email-receiving unit 620 comprise identification handshake logic 640.

In operation, the identification handshake logic 640 of the email-transmitting unit 602 requests from the identification handshake logic 640 on the email-receiving unit 620 acceptance for receiving data. In this regard, the identification handshake logic 640 of the transmitting unit 602 transmits an encrypted request to the email-receiving unit 620, and the identification handshake logic 640 on the email-receiving unit 620 can either accept or reject the email transmitting unit's request to communicate. The encrypted request may be encrypted according to any of the techniques described above. The encrypted request comprises a unique identifier corresponding to the transmitting unit 602, for example, the transmitting unit's IP address, the user's email address, or other unique identifying information.

A user of the email-receiving unit 620 receives the request. In receiving the request, the user views the user identification data of the user of the transmitting unit 602. The user then provides input indicating acceptance or rejection.

If the input indicates acceptance, the email-receiving unit 620 stores the unique identifier sent in the aforementioned request, and the user of the email-transmitting unit 602 is thereafter a “trusted source.” Note that the unique identifier may be stored in a protected authentication file and used, as described above, to decrypt future messages. As described above, the unique identifier may comprise, for example, the transmitters' email address, phone number, physical address, or any other unique identification data.

In addition, the email-receiving unit 620 transmits at least one unique identifier to the email-transmitting unit 602 identifying the email-receiving unit 620. In one embodiment, the key access logic 616 of the email-transmitting unit 602 can use the unique identifiers of the transmitting unit 602 and/or receiving unit 620 as part of a key 612 generated by the key access logic 616.

When the email-transmitting unit 602 transmits an email message to the email-receiving unit 620, the key access logic 620 on the transmitting unit 602 provides the key 612. The encryption logic 618 of the transmitting unit 602 uses the key 612 to encrypt the email message to generate an encrypted email message 624 that the user desires to transmit to the email-receiving unit 620.

As described above, the key can comprise the unique identifier of the email-receiving unit 620. In addition, the key can comprise the unique identification data 630 of the transmitting unit 602 and possibly other data indicative of a key that may be used to encrypt the email message that is to be sent to the email-receiving unit 620. The email-transmitting unit 602 then encrypts the email message with the generated key 612, encrypts the key 612 to generate encrypted key 626, and transmits an encrypted email message 624 and the encrypted key 626 to the email-receiving unit 604.

As described hereinabove with reference to FIG. 2, the encrypted key 626 can comprise key data 627 and key decryption data 628. The key data 627 and the key decryption data 628 preferably comprise data uniquely identifying the email transaction, i.e., data and/or time data, and data location points of reference that can be used to decrypt the key 626.

Upon receipt, the authentication logic 606 of the decryption application 601 of the email-receiving unit 604 behaves as described with reference to the communication embodiment as depicted in FIGS. 2-3. However, after the authentication logic 606 verifies the user of the email-receiving unit 620, and the decryption logic 608 uses data from the authentication file 680 to decrypt the key 626, the decryption logic 608 may then compare the identifiers, in the email message, with the identifiers stored by the email-receiving unit 620 in the decrypted key with that information stored for the unit's trusted sources. If the transmitted identifiers match the stored identifiers, then the decryption logic 608 receives and decrypts the email message 624. Otherwise, the application 201 does not recognize the message 624 as coming from a trusted source and refrains from decrypting the message.

To better illustrate the foregoing, assume that a first identifier, hereinafter referred to as “identifier A,” identifies the transmitting unit 602 or the user of unit 602 and that a second identifier, hereinafter referred to as “identifier B,” identifies the receiving unit 620 or the user of unit 620. Such identifiers are initially exchanged via a handshaking methodology, as described above. For example, the unit 602 may transmit a request that includes identifier A to receiving unit 620. If the request is accepted by the user of the unit 620, the decryption application 601 stores identifier A in the authentication file 680, which also stores identifier B, and the receiving unit 620 transmits identifier B to transmitting unit 602. Thereafter, assume that an email message is to be transmitted from transmitting unit 602 to receiving unit 620.

In this regard, the user of transmitting unit 602 composes an email message comprising text that is to be displayed by the receiving unit 620. The encryption logic 618 generates a key 612 comprising identifier A, identifier B, and a random number, although the key 612 can comprise other information in other examples. This key 612 is then used to encrypt the text of the email message. The encryption logic 618 then encrypts the key 612 to form encrypted key 626 and embeds this key 626 within a data packet 604 along with the email message. Included in the key 626 is key decryption data 628 for enabling the receiving unit 620 to recover the original key 612. The transmitting unit 602 then transmits the data packet 604, including the email message and encrypted key 626, to the receiving unit 620.

To read the email message, the user of the receiving unit 620 invokes the decryption application 601, which accesses the authentication file 680. The decryption application 601 performs a checksum check, as described above, to ensure that the file 680 has not been corrupted. If the checksum check indicates that the file 680 is uncorrupted, the application 601 authenticates the user of the receiving unit 620 using the unique identification data 602 within the file 680. If the user is authenticated, the application 601 allows the user to request viewing of the email message transmitted from the transmitting unit 602.

In response to such a request, the application 601 locates the key decryption data 628 within the data packet 604 of the email message and uses this data 628 to locate and/or decrypt the encrypted key in order to recover key 612. The application 601 also compares identifiers A and B from the email message to the identifiers A and B stored in the authentication file 680. If stored identifier A matches identifier A from the message and if the stored identifier B matches identifier B from the message, the application 601, using key 612, decrypts and displays the email message. Otherwise, the application 601 discards, without displaying, the email message and reports to the user that it is from an unreliable source. It should be noted that the foregoing methodology is exemplary and various changes may be made to the methodology without departing from the principles of the present disclosure.

1. A system for communicating encrypted messages, comprising:
memory for storing a data file; and
a decryption application configured to authenticate a user and to receive a data packet, the data packet having a data message encrypted via an encrypted encryption key that is embedded within the data packet, the decryption application configured to decrypt the data message based on the embedded encryption key and to interface the decrypted data message with the user if the user is authenticated by the decryption application, wherein the decryption application is configured to recover the encryption key and to decrypt the data message based on data within the data packet and based on data within the data file, and wherein the decryption application controls access to the data within the data file based on whether the user is authenticated by the decryption application.

2. The system of claim 1, wherein the data file comprises authentication data that is used by the decryption application to authenticate the user.

3. The system of claim 2, wherein the authentication data comprises biometric data.

4. The system of claim 1, wherein the decryption application is configured to detect whether the data file has been accessed by an unauthorized application.

5. The system of claim 1, wherein the data file comprises header information, wherein the decryption application is configured to store a value indicative of the header information, and wherein the decryption application is configured to calculate a new value indicative of the header information when the decryption application accesses the data file and to compare the new value with the stored value.

6. The system of claim 1, wherein the decryption application is configured to calculate a checksum for data within the data file.

7. The system of claim 6, wherein the decryption application is configured to permit access to the data file based on the checksum.

8. The system of claim 1, wherein the decryption application is configured to prevent the user from making copies of the decrypted data message.

9. The system of claim 8, wherein the decryption application prevents the user from making copies by repetitively writing to a clipboard.

10. The system of claim 1, wherein the data file comprises an identifier associated with a user of a remote communication device that transmitted the data packet, wherein the identifier is stored within the data file, and wherein the decryption application is configured to determine whether to interface the data message with the user by comparing data from the data packet with the identifier stored within the data file.

11. The system of claim 10, wherein the identifier identifies the remote communication device.

12. The system of claim 10, wherein the encryption key comprises the identifier.

13. The system of claim 12, wherein the data file comprises authentication data that is used by the decryption application to authenticate the user.

14. The system of claim 13, wherein the authentication data comprises biometric data.

15. A system for communicating encrypted messages, comprising:
means for storing a data file;
means for receiving a data packet, the data packet having a data message and an encrypted encryption key, the data message encrypted via the encrypted encryption key, the data packet also having data that enables decryption of the encrypted encryption key;
means for authenticating a user;
means for accessing data within the data file if the user is authenticated via the authenticating step;
means for decrypting the encrypted encryption key based on the data that enables decryption of the encrypted encryption key;
means for decrypting the data message based on the encryption key;
means for interfacing the decrypted data message with the user; and
means for enabling at least one of the decrypting the data message means and the interfacing means based on the data accessed via the accessing.

16. A computer readable medium having a program, the program comprising:
logic receiving a data packet, the data packet having a data message and an encrypted encryption key, the data message encrypted via the encrypted encryption key, the data packet also having data that enables decryption of the encrypted encryption key;
logic for authenticating a user;
logic for accessing data within a data file if the user is authenticated via the authenticating step;
logic for decrypting the encrypted encryption key based on the data that enables decryption of the encrypted encryption key;
logic for decrypting the data message based on the encryption key;
logic for interfacing the decrypted data message with the user; and
logic for enabling at least one of the logic for decrypting the data message and the logic for interfacing based on the data accessed via the accessing.

17. A method for communicating encrypted messages, comprising the steps of:
storing a data file;
receiving a data packet, the data packet having a data message and an encrypted encryption key, the data message encrypted via the encrypted encryption key, the data packet also having data that enables decryption of the encrypted encryption key;
authenticating a user;
accessing data within the data file if the user is authenticated via the authenticating step;
decrypting the encrypted encryption key based on the data that enables decryption of the encrypted encryption key;
decrypting the data message based on the encryption key;
interfacing the decrypted data message with the user; and
enabling at least one of the decrypting the data message step and the interfacing step based on the data accessed via the accessing.

18. The method of claim 17, wherein the data file comprises authentication data, and wherein the authenticating step is based on the authentication data.

19. The method of claim 18, wherein the authentication data comprises biometric data.

20. The method of claim 17, further comprising the step of detecting an unauthorized access of the data file.

21. The method of claim 20, wherein the data file comprises header information, and wherein the detecting step is based on the header information.

22. The method of claim 17, further comprising the step of calculating a checksum for data within the data file.

23. The method of claim 22, further comprising the step of permitting access to the data file based on the checksum.

24. The method of claim 17, further comprising the step of preventing the user from making copies of the decrypted data message.

25. The method of claim 24, wherein the preventing step comprises the step of repetitively writing to a clipboard.

26. The method of claim 17, wherein the data file comprises an identifier associated with a user of a remote communication that transmitted the data packet, wherein the identifier is stored within the data file, and wherein the method further comprises the steps of:
comparing data from the data packet with the identifier stored within the data file; and
enabling at least one of the decrypting the data message step and the interfacing step based on the comparing step.

27. The method of claim 26, wherein the encryption key comprises the identifier.

28. The method of claim 27, wherein the data file comprises authentication data, and wherein the authenticating step is based on the authentication data.

29. The method of claim 28, wherein the authentication data comprises biometric data.
